(19) United States
(12) Patent Application Publication
(10) Pub. No.: US 2025/0303343 A1
(43) Pub. Date: Oct. 2, 2025

(54) Detachable Adsorption Tower for Portable Oxygen Generators

(71) Applicant: Bing Zhu, Shenzhen (CN)

(72) Inventor: Bing Zhu, Shenzhen (CN)

(21) Appl. No.: 19/091,919

(22) Filed: Mar. 27, 2025

(30) Foreign Application Priority Data
Mar. 29, 2024 (CN) 202420638379.8

(51) Int. Cl. B01D 53/04

(52) U.S. Cl. CPC B01D 53/0423; B01D 2256/12; B01D 2257/102; B01D 2258/06; B01D 2259/4541

(57) ABSTRACT

The invention relates to the technical field of adsorption towers, and more specifically, to a detachable adsorption tower for portable oxygen generators. The entire device is installed within a mounting frame and includes a tower cover, an adsorption tower, and a ventilation component. The adsorption tower is located at a center of the mounting frame. An end of the mounting frame is provided with a slot, and the tower cover is equipped with a buckle that engages with the slot. The tower cover is detachably connected to the adsorption tower via the mounting frame. An end of the adsorption tower which is away from the tower cover is detachably connected to the ventilation component, which is located inside the mounting frame and is detachably connected to the mounting frame.

### CROSS-REFERENCE TO RELATED APPLICATIONS

The application claims priority to Chinese patent application No. 202420638379.8, filed on Mar. 29, 2024, the entire contents of which are incorporated herein by reference.

### TECHNICAL FIELD

The invention relates to the technical field of adsorption towers, and more specifically, to a detachable adsorption tower for portable oxygen generators.

### BACKGROUND ART

With a popularization and promotion of oxygen therapy, as well as a demand for outdoor oxygen use, especially in high-altitude areas, small portable oxygen generators have become a development trend in oxygen production equipment.

Among these, an adsorption tower is a key component of the oxygen generator. Currently, most portable oxygen generators using the PSA (Pressure Swing Adsorption) principle on the market are equipped with non-detachable adsorption towers. For example, a invention patent with publication number CN 216687498 U discloses a miniature adsorption tower for portable oxygen generators. The miniature molecular sieve adsorption tower has a ring structure, including a coaxial outer tower cylinder, an inner sleeve, and an air duct. The outer tower cylinder and the inner sleeve form an outer annular cavity, while the inner sleeve and the air duct form an inner annular cavity. Both the outer and inner annular cavities are filled with molecular sieves. An intake pipe of a lower end cover is connected to the outer annular cavity, which is in turn connected to the inner annular cavity. Near an end of the lower end cover, the inner annular cavity is connected to one end of the air duct, and the other end of the air duct is connected to an exhaust pipe of an upper end cover. This design enhances uniform airflow distribution and prevents molecular sieve pulverization caused by movement, thereby improving a lifespan of the molecular sieves and featuring a compact, lightweight, and small-sized structure.

However, due to physical characteristics of molecular sieves and complexity of outdoor environments, adsorption towers are prone to failure. This can significantly reduce an oxygen production capacity of portable oxygen generators. Therefore, a replaceability of the adsorption towers become crucial, as it can lower user procurement costs and conserve resources.

### SUMMARY OF THE INVENTION

To address the aforementioned issues, the invention provides a modular and easily replaceable adsorption tower for portable oxygen generators.

To achieve the above objectives, the invention offers the following technical solutions, which mainly include:
a detachable adsorption tower for portable oxygen generators, which is entirely installed within a mounting frame and includes a tower cover, an adsorption tower, and a ventilation component, wherein the adsorption tower is located at a center of the mounting frame, an end of the mounting frame is provided with a slot, and the tower cover is equipped with a buckle that engages with the slot, the tower cover is detachably connected to the adsorption tower via the mounting frame, an end of the adsorption tower which is away from the tower cover is detachably connected to the ventilation component, which is located inside the mounting frame and is detachably connected to the mounting frame.

Preferably, an end of the adsorption tower near the tower cover is an oxygen outlet end, which is connected to an oxygen outlet. The oxygen outlet is detachably connected to a hose connector via threads. The hose connector is equipped with a hose, which is connected to external equipment.

Preferably, a connecting structure is provided at a side of the ventilation component. An end of the adsorption tower near the ventilation component is a ventilation end, which is compatible with the connecting structure.

Based on the above technical solutions, compared to the existing technology, the invention has the following beneficial effects:
(1) Each functional component adopts a modular design, especially the adsorption tower component, to achieve a design goal of easy replacement.
(2) The air intake and exhaust contact parts use long guidance and soft contact methods to ensure multiple replacements and easy replacement.
(3) The oxygen outlet part adopts stainless steel or nickel-plated brass threaded connections to ensure a secure connection; it also ensures that the machine's shaking during outdoor use does not affect a stable connection between the adsorption tower and the ventilation system.

### BRIEF DESCRIPTION OF THE DRAWINGS

To more clearly illustrate embodiments of the invention or technical solutions in the prior art, the following will briefly introduce accompanying drawings required for describing the embodiments or the prior art. Obviously, the drawings in the following description are only embodiments of the invention. For those skilled in the art, other drawings can be obtained based on the provided drawings without creative effort.

FIG. 1 is a schematic diagram of the front three-dimensional structure of the invention.

FIG. 2 is a schematic diagram of the rear three-dimensional structure of the invention.

FIG. 3 is a schematic diagram of the three-dimensional structure of the tower cover of the invention.

FIG. 4 is an exploded view of the three-dimensional structure of the oxygen outlet end of the invention.

FIG. 5 is an exploded view of the three-dimensional structure of the ventilation end of the invention.

### DESCRIPTION OF REFERENCE NUMERALS

1-Mounting frame, 101-Slot, 2-Tower cover, 201-Buckle, 3-Adsorption tower, 301 Oxygen outlet end, 302-Oxygen outlet, 303-Hose connector, 304-Ventilation end, 4-Ventilation component, 401-Connecting structure.

### DETAILED DESCRIPTION OF THE INVENTION

Technical solutions in embodiments of the invention will be clearly and completely described below in conjunction with accompanying drawings. Obviously, the described embodiments are only a part of the embodiments of the invention, rather than all of them. Based on the embodiments of the invention, all other embodiments obtained by those skilled in the art without creative effort shall fall within the protection scope of the invention.

### Embodiment

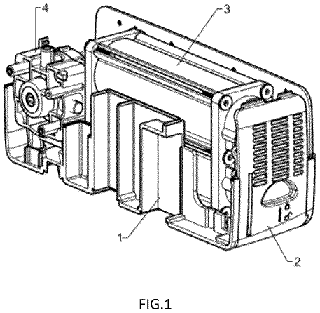

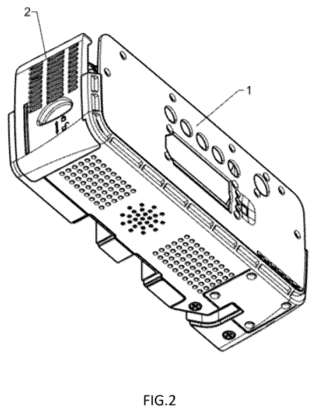

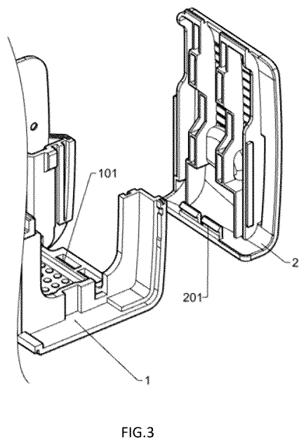

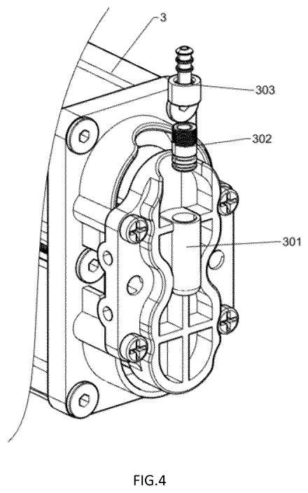

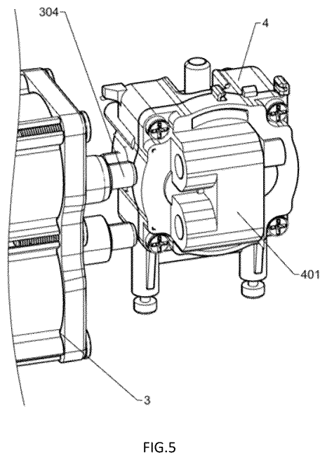

A detachable adsorption tower for portable oxygen generators, as shown in FIGS. 1-5, is entirely installed within a mounting frame 1 and includes a tower cover 2, an adsorption tower 3, and a ventilation component 4. The adsorption tower 3 is located at the center of the mounting frame 1. An end of the mounting frame 1 is provided with a slot 101, and the tower cover 2 is equipped with a buckle 201 that engages with the slot 101. The tower cover 2 is detachably connected to the adsorption tower 3 via the mounting frame 1. An end of the adsorption tower 3 which is away from the tower cover 2 is detachably connected to the ventilation component 4, which is located inside the mounting frame 1 and is detachably connected to the mounting frame 1.

To further optimize the above solution, an end of the adsorption tower 3 near the tower cover 2 is an oxygen outlet end 301, which is connected to an oxygen outlet 302. The oxygen outlet 302 is detachably connected to a hose connector 303 via threads. The hose connector 303 is equipped with a hose, which is connected to external equipment (such as the oxygen outlet of the oxygen generator).

To further optimize the above solution, the ventilation component 4 is provided with a connecting structure 401 on one side. The end of the adsorption tower 3 near the ventilation component 4 is a ventilation end 304, which is compatible with the connecting structure 401.

During a development phase of the portable oxygen generator, each functional component adopts a modular design, especially the the adsorption tower 3 component, to achieve the design goal of easy replacement.

To ensure multiple replacements and easy replacement, the air intake and exhaust contact parts use long guidance and soft contact methods. The oxygen outlet part (oxygen outlet 302 and hose connector 303) adopts stainless steel or nickel-plated brass threaded connections to ensure a secure connection. It also ensures that the machine's shaking during outdoor use does not affect the stable connection between the adsorption tower 3 and the ventilation system.

The various embodiments in this specification are described in a progressive manner, with each embodiment focusing on the differences from other embodiments. The same or similar parts between the embodiments can be referred to each other. For the device disclosed in the embodiments, since it corresponds to the method disclosed in the embodiments, the description is relatively simple. For relevant parts, refer to the method section for details.

The above description of the disclosed embodiments enables those skilled in the art to implement or use the invention. Various modifications to these embodiments will be obvious to those skilled in the art. The general principles defined herein can be implemented in other embodiments without departing from the spirit or scope of the invention. Therefore, the invention is not limited to the embodiments shown herein but shall conform to the broadest scope consistent with the principles and novel features disclosed herein.

What is claimed is:

1. A detachable adsorption tower for portable oxygen generators, wherein that the detachable adsorption tower is entirely installed within a mounting frame (1) and includes a tower cover (2), an adsorption tower (3), and a ventilation component (4), the adsorption tower (3) is located at a center of the mounting frame (1), an end of the mounting frame (1) is provided with a slot (101), the tower cover (2) is equipped with a buckle (201) that engages with the slot (101), the tower cover (2) is detachably connected to the adsorption tower (3) via the mounting frame (1), and an end of the adsorption tower (3) which is away from the tower cover (2) is detachably connected to the ventilation component (4), which is located inside the mounting frame (1) and is detachably connected to the mounting frame (1).

2. The detachable adsorption tower for portable oxygen generators according to claim 1, wherein an end of the adsorption tower (3) near the tower cover (2) is an oxygen outlet end (301), the oxygen outlet end (301) is connected to an oxygen outlet (302), the oxygen outlet (302) is detachably connected to a hose connector (303) via threads, and the hose connector (303) is equipped with a hose, which is connected to external equipment.

3. The detachable adsorption tower for portable oxygen generators according to claim 1, wherein a connecting structure (401) is provided at a side of the ventilation component (4), an end of the adsorption tower (3) near the ventilation component (4) is a ventilation end (304), and the ventilation end (304) is compatible with the connecting structure (401).
